(19) United States
(12) Patent Application Publication
(10) Pub. No.: US 2023/0112715 A1
(43) Pub. Date: Apr. 13, 2023

(54) Cooking device

(71) Applicant: Ningbo Singfun Electric Appliance Co.,Ltd., Cixi (CN)

(72) Inventors: Haibing Xie, Cixi (CN); Xinbo Dang, Cixi (CN); Zhaoping Dai, Cixi (CN); Yuchu Yao, Cixi (CN)

(73) Assignee: Ningbo Singfun Electric Appliance Co.,Ltd., Cixi (CN)

(21) Appl. No.: 18/045,191

(22) Filed: Oct. 10, 2022

(30) Foreign Application Priority Data
Oct. 13, 2021 (CN) 202111193943.7
Oct. 13, 2021 (CN) 202122466239.6
Mar. 4, 2022 (CN) 202220465912.6
Aug. 25, 2022 (CN) 202222253428X

(51) Int. Cl. A47J 27/00

(52) U.S. Cl. CPC A47J 27/004; A47J 27/002

(57) ABSTRACT

The present application relates to a cooking device, comprising an inner shell, wherein a heat insulating plate is arranged in the inner shell; a heating assembly is arranged above the heat insulating plate; the heating assembly comprises a heating element and a heating plate; the heating plate is arranged above the heating element; an air duct is arranged between the heat insulating plate and the heating plate; air holes are formed at ends of the heating plate; a cooking plate is further arranged on the heating plate; air vents are formed on the cooking plate; the air vents are communicated with the air holes of the heating plate; and, the air duct is communicated with the air holes of the heating plate.

### TECHNICAL FIELD

The present application relates to a cooking device.

### BACKGROUND

The existing cooking devices such as baking trays are limited by the design of the oil fume flow channel, and most of the heating elements are directly exposed under the cooking plate, so grease is easily attached to the heating elements and will produce additional oil fume after being heated at a high temperature. However, for most of fume exhaust devices, centrifugal wind wheels are additionally provided on a side, resulting in a large size; and, air enters from one side and exits from the opposite side after surrounding the bottom. Since the heat circulation path is relatively long, the food is heated unevenly, and the heat loss is high. In addition, since there are many assembly gaps, it is easier to accumulate oil dirt, and it is difficult to clean.

Therefore, in the prior art, there is a need for a baking tray which can realize even heating and reduce the accumulation of oil fume, particularly on heating elements, and is convenient to assemble or disassemble and easy to clean.

### SUMMARY

An objective of the present application is to design a cooking device, which can heat food evenly and is convenient to assemble or disassemble and easy to clean.

The present application relates to a cooking device, including an inner shell, wherein a heat insulating plate is arranged in the inner shell; a heating assembly is arranged above the heat insulating plate; the heating assembly includes a heating element and a heating plate; the heating plate is arranged above the heating element; an air duct is arranged between the heat insulating plate and the heating plate; air holes are formed at ends of the heating plate; a cooking plate is further arranged on the heating plate; air vents are formed on the cooking plate; the air vents are communicated with the air holes of the heating plate; and, the air duct is communicated with the air holes of the heating plate.

An air hole is formed in the middle of the heating plate, the air duct is arranged on the heat insulating plate or on the bottom of the heating plate, and the air duct is communicated with the air hole; a gap is arranged between the cooking plate and the heating plate or a through hole is formed on the bottom of the cooking plate; a motor is arranged below the inner shell, a motor shaft of the motor is connected to a fan, and the fan is arranged in the air duct; and, the motor shaft penetrates through the heat insulating plate, a groove is formed on the heat insulating plate, the fan is arranged in the groove, and the groove is communicated with the air duct.

The air vents are formed at two ends of the cooking plate, the air holes are formed at two ends of the heating plate, and the air vents of the cooking plate are communicated with the air holes of the heating plate; the air duct includes an air duct plate, and the air duct plate is arranged on the heat insulating plate and forms an air duct chamber with the heat insulating plate; the air duct is communicated with the air vents of the cooking plate and the air holes of the heating plate; and, a heat reflector is arranged below the heating plate.

The heat insulating plate is provided with an inclined concave surface, and the edge of the heating plate is fixedly attached to the inclined concave surface of the heat insulating plate to form an overflow groove; the heat insulating plate is matched with the inner shell in shape, and the edge of the heat insulating plate is connected to the edge of the inner shell through a clasp; a protective switch linked with the cooking plate is further provided, and the protective switch is fixed on the inner shell and passes through the inner shell and the heat insulating plate; the protective switch includes an induction boss, a moving pin, a switch bracket and a microswitch, the induction boss is engaged with the moving pin, and the induction boss, the moving pin and the microswitch are all arranged on the switch bracket; an oil collecting groove arranged circumferentially is formed on the upper edge of the heat insulating plate; and, an oil receiving box is further arranged on the bottom of the cooking device, and the oil receiving box is communicated with the oil collecting groove through an oil leakage hole.

### BRIEF DESCRIPTION OF THE DRAWINGS

FIG. 1 shows an exploded view of the cooking device according to Embodiment 1 of the present application;

FIG. 2 shows an internal structure diagram of the cooking device according to Embodiment 1 of the present application;

FIG. 3 shows a schematic diagram of the flow direction of air in the cooking device according to Embodiment 1 of the present application;

FIG. 4 shows a schematic diagram of the air inlets and air outlets of the cooking device according to Embodiment 1 of the present application;

FIG. 5 shows a sectional view of the cooking device according to Embodiment 2 of the present application;

FIG. 6 shows an exploded view of the cooking device according to Embodiment 2 of the present application;

FIG. 7 shows a partially sectional view of the cooking device according to Embodiment 2 of the present application;

FIG. 8 shows a schematic diagram of the protective switch of the cooking device according to Embodiment 2 of the present application;

FIG. 9 shows a schematic diagram of flowing of air in the cooking device according to Embodiment 2 of the present application;

FIG. 10 shows a schematic diagram of the overflow groove of the cooking device according to Embodiment 2 of the present application;

FIG. 11 shows an exploded view of the cooking device according to Embodiment 3 of the present application;

FIG. 12 shows an internal structure diagram of the cooking device according to Embodiment 3 of the present application;

FIG. 13 shows a schematic diagram of the flow direction of air in the cooking device according to Embodiment 3 of the present application; and

FIG. 14 shows a schematic diagram of the air inlets and air outlets of the cooking device according to Embodiment 3 of the present application.

### DETAILED DESCRIPTION

In order to make the objectives, technical solutions and advantages of the present application clearer, the embodiments of the present application will be described below in detail with reference to the accompanying drawings. The technical features in different embodiments of the present application may be combined with each other if not conflicted.

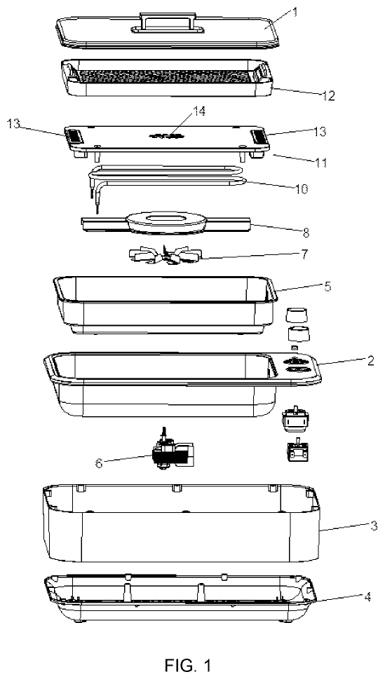

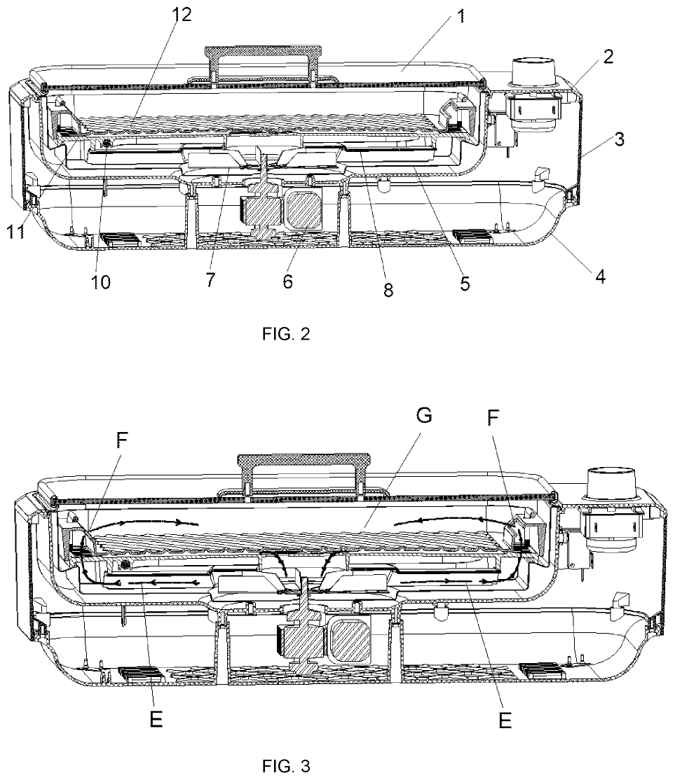

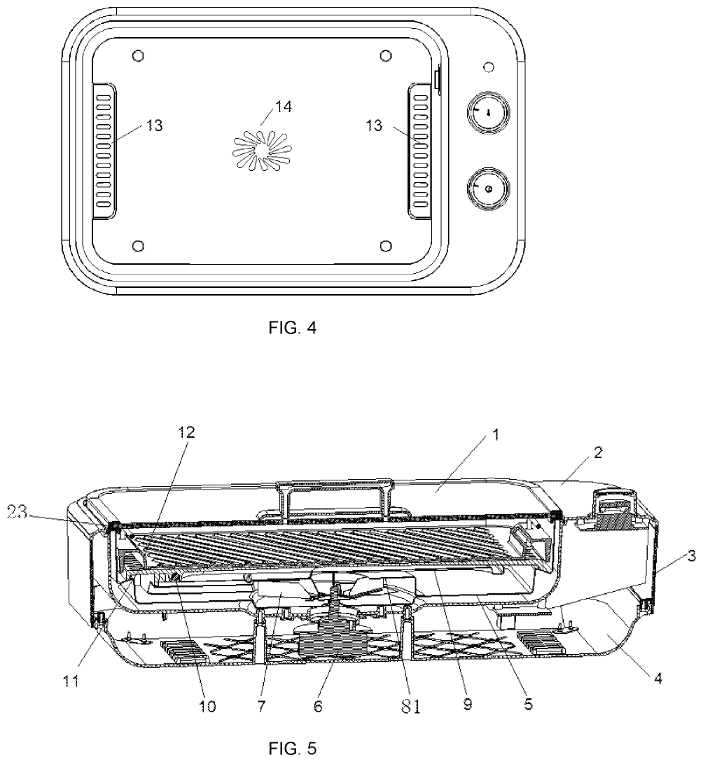

In accordance with Embodiment 1 of the cooking device of the present application, as shown in FIGS. 1-4, the cooking device includes a main body, a top cover 1 is arranged on the top of the main body, and the main body is covered with the top cover 1 to form a cooking chamber G. The main body includes an inner shell 2, an outer shell 3 and a bottom shell 4. A concave chamber for accommodating a heating assembly and an air duct is arranged in the inner shell 2, and the inner shell 2, the outer shell 3 and the bottom shell 4 enclose an accommodating chamber for accommodating electrical components or other components. A heat insulating plate 5 is arranged in the inner shell 2, a heating assembly is arranged above the heat insulating plate 5, and a motor 6 is arranged below the inner shell 2. The heating assembly includes a heating element 10 and a heating plate 11 with a heat conduction function. The heating plate 11 is arranged above the heating element 10. An air duct 8 is arranged between the heat insulating plate 5 and the heating plate 11. The air duct 8 may be arranged on the heat insulating plate 5 of the main body and form an air duct chamber E with the heat insulating plate 5, or may be arranged on the bottom of the heating plate 11 and form an air duct chamber with the heating plate 11. It should be understood by those skilled in the art that all other possible modes satisfying the hot air circulation can also be adopted. Air outlets 13 are formed at two ends of the heating plate 11, and air inlets 14 are formed in the middle of the heating plate 11. The air duct chamber E is communicated with the air outlets 13 at two ends of the heating plate 11 and the air inlets 14 in the middle of the heating plate 11. A cooking plate 12 is placed on the heating plate 11, and air vents F are also formed at two ends of the cooking plate 12 and are communicated with the air outlets 13 at two ends of the heating plate 11 and the air duct chamber E. A gap is reserved between the cooking plate 12 and the heating plate 11 for allowing hot air in the cooking chamber G to circulate and flow back to the air inlets 14. The cooking plate 12 with a through hole on its bottom may also be adopted. In the present application, the air outlets are formed at two ends of the heating plate and the air inlets are formed in the middle of the heating plate, so that the air duct is communicated with the air outlets at two ends of the heating plate and the air inlets in the middle of the heating plate. Thus, the circulating air flow can cook the food evenly and then flow back to the air duct from the middle of the heating plate, so that the food is heated evenly, and the evenness of cooked food is improved.

The motor 6 may be arranged in the accommodating chamber enclosed by the inner shell 2, the outer shell 3 and the bottom shell 4. A fan 7 is further arranged in the main body. The fan 7 is arranged in the air duct chamber E and fixedly connected to a motor shaft of the motor 6. The motor shaft of the motor 6 passes through the inner shell 2 and the heat insulating plate 5. A groove may be formed in the middle of the heat insulating plate 5 to be matched with the air duct 8 so as to increase the space for accommodating the fan. The motor 6 drives the fan 7 to rotate to blow heat to the cooking chamber G through the air duct chamber E and the air outlets 13 at two ends of the heating plate 11 for circulation. A negative pressure will be generated after air in the air duct chamber E is discharged from two ends, and the hot air in the cooking chamber G is sucked into the air duct chamber E through the air inlets 14, so that the hot air in the cooking chamber G circulates back and forth to evenly heat the food in the cooking plate. Meanwhile, the design of the flow channel can reduce the accumulation of oil fume at the heating element, thereby avoiding the trouble of cleaning the heating element. It is to be noted that the positions and functions of the air outlets and the air inlets may be interchanged. In this case, it is only necessary to design the motor and the fan in opposite directions, that is, the air flow direction shown in FIG. 3 may also be designed as being opposite. The above alterations are simple alterations easily conceived and made by those skilled in the art based on the above disclosure, and shall also fall into the protection scope of the present application.

In the cooking device according to Embodiment 1 of the present application, hot air can be blown simultaneously from two ends of the cooking plate and then flow back from the middle of the cooking plate, so that the flow path of the hot air is shortened. Accordingly, the baking temperature in the cooking chamber can be increased quickly, the temperature difference between different positions in the cooking chamber can be reduced, the cooking time can be shortened, and even heating can be realized. In addition, the overflow of water vapor generated by baking food during the circulation process can be better kept, so that the water vapor can only circulate in the air duct chamber and will not be accumulated on the heating. Therefore, the cooking device has the characteristics of easy cleaning and convenient disassembling.

In accordance with Embodiment 2 of the cooking device of the present application, as shown in FIGS. 5-10, the cooking device includes a base assembly. A top cover 1 is arranged above the base assembly. The base assembly is covered with the top cover 1 to form a cooking chamber G. It is also possible to not provide the top cover as required. The base assembly includes an inner shell 2, an outer shell 3 and a bottom shell 4. A concave chamber for accommodating a heating assembly 22 is arranged in the inner shell 2, and the inner shell 2, the outer shell 3 and the bottom shell 4 enclose an accommodating chamber for accommodating electrical components or other components. The base assembly is provided with an air duct assembly 21 and a heating assembly 22. The air duct assembly 21 is arranged below the heating assembly 22, and both the air duct assembly 21 and the heating assembly 22 are engaged to the base assembly. The air duct assembly 21 and the heating assembly 22 cooperate with each other to circulate the hot air in the cooking chamber G so as to cook the food, so that the oil fume can be taken away and the accumulation of oil fume vapor can be reduced. The cooking plate 12 is arranged on the heating assembly 22, and can be movably arranged in the cooking chamber G to place the food to be cooked.

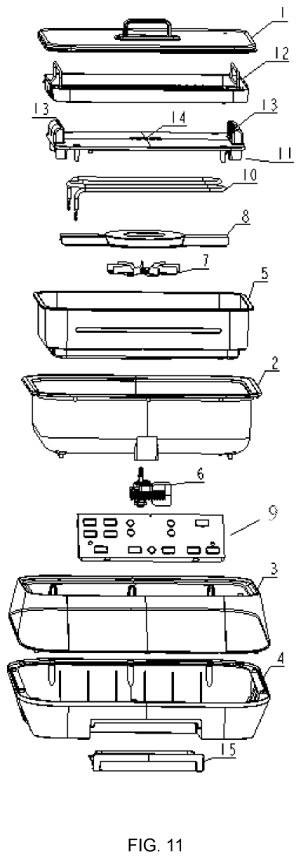

A heat insulating plate 5 is arranged in the inner shell 2. The heat insulating plate 5 is matched with the inner shell 2 in shape, and the peripheral edge of the heat insulating plate 5 is connected to the peripheral edge of the inner shell 2, for example, through a clasp. The heating assembly 22 includes a heating element 10 and a heating plate 11 with a heat conduction function. The heating plate 11 is placed above the heating element 10, and air holes A and B for ventilation and convection are formed at two ends of the heating plate 11. A cooking plate 12 is placed on the heating plate 11 of the heating assembly 22, and air holes F are also formed at two ends of the cooking plate 12 and are communicated with the air holes A and B of the heating plate 11 and the air duct chamber E. Preferably, the heating element 10 may be internally fixed in a tube slot which is integrally formed with the heating plate 11, and a heat reflector 9 may be arranged below the heating plate 11 to reflect the heat back to the heating plate. As shown in FIGS. 9-10, the edge of the heating plate 11 is fixedly fitted with the inclined concave surface of the heat insulating plate 5, so as to form a circle of overflow groove C with the heat insulating plate 5. This structure can effectively store the liquid overflowed during the cooking process and prevent the liquid from overflowing into the interior of the smokeless baking tray.

The air duct assembly 21 includes an air duct plate 81, a fan 7 and a motor 6. The motor 6 is arranged in an accommodating chamber enclosed by the inner shell 2, the outer shell 3 and the bottom 4. The air duct plate 81 is fixedly arranged on the heat insulating plate 5 of the base assembly and forms an air duct chamber E with the heat insulating plate 5. The air duct chamber E is communicated with the air holes A and B of the heating plate 11. The fan 7 is arranged in the air duct chamber E and fixedly connected to the motor shaft of the motor 6. The motor shaft of the motor 6 passes through the inner shell 2 and the heat insulating plate 5. Preferably, a groove is formed in the middle of the heat insulating plate 5 to be matched with the air duct plate 81 so as to increase the space for accommodating the fan. The motor 6 in the air duct assembly 21 drives the fan 7 to rotate to blow heat to the cooking chamber G through the air duct chamber E and the air holes A and B at two ends of the heating plate 11 for circulation. A negative pressure will be generated after air in the air duct chamber E is discharged, and the hot air in the cooking chamber G is sucked into the air duct chamber E through convection holes B as shown in FIG. 9, so that the hot air in the cooking chamber G circulates back and forth to evenly heat the food in the cooking plate 12. Meanwhile, the design of the flow channel can reduce the accumulation of oil fume at the heating element, thereby avoiding the trouble of cleaning the heating element.

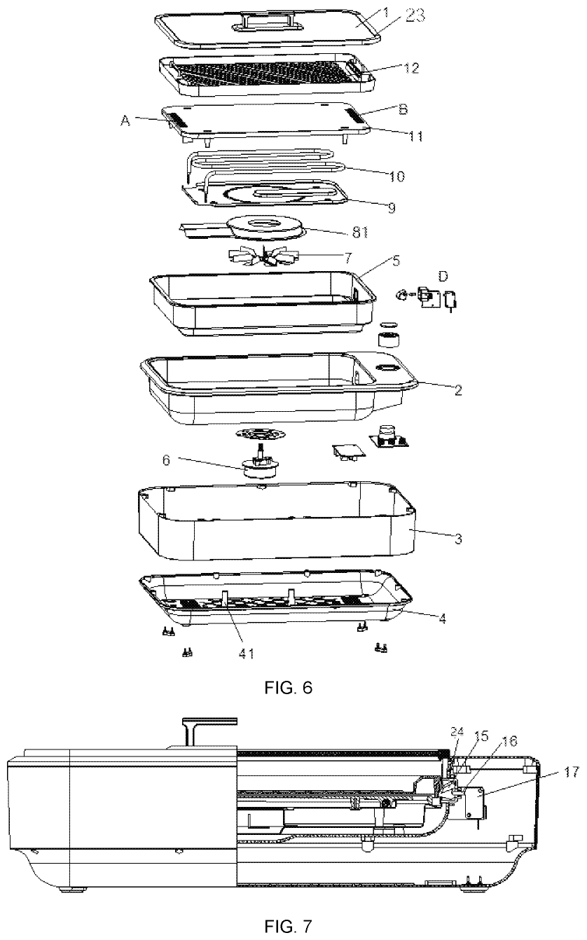

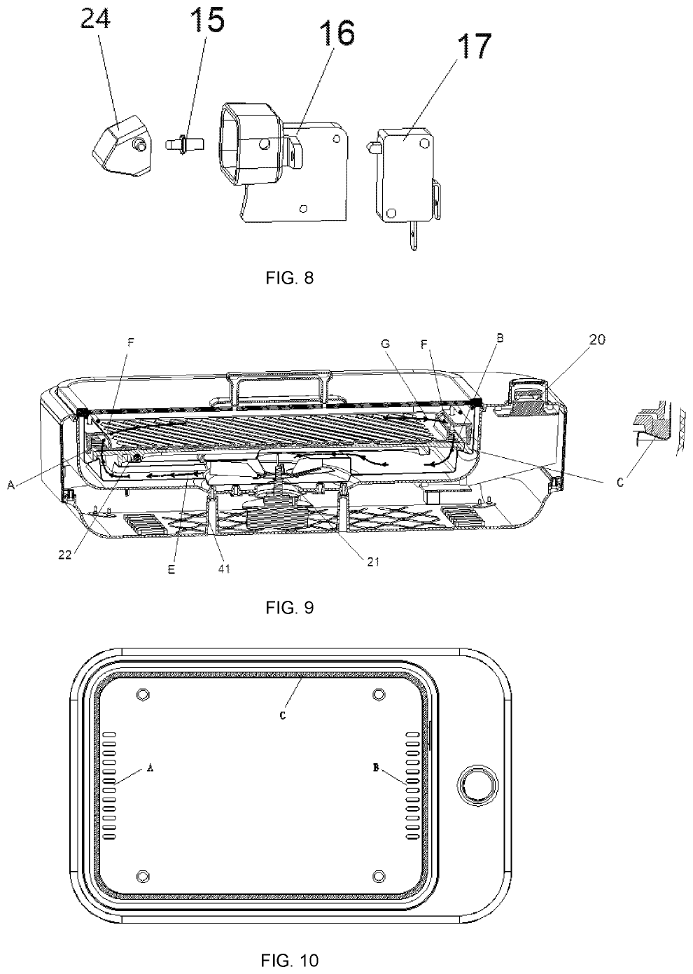

As shown in FIGS. 6-9, some identical features of the cooking devices according to Embodiment 1 and Embodiment 2 of the present application are also shown. As shown, a support member 41 extending upward is arranged on the inner side of the bottom shell 4, a support hole is formed on the bottom of the inner shell, and the support member 41 on the bottom shell 4 is inserted into the support hole on the bottom of the inner shell 2 to fix and support the inner shell 2 on the bottom shell 4. The upper and lower ends of the outer shell 3 are engaged to the inner shell 2 and the bottom shell 4, respectively. The inner shell and the outer shell may also be formed as an integral structure as required. A silicone sealing member 23 may be wrapped outside the outer edge of the top cover 1, and the inner shell 2 is covered with the top cover 1 to realize the sealing fit of the cooking chamber. The multifunctional smokeless baking tray in the present application may further include an electrically-controlled adjustment assembly 20. The electrically-controlled adjustment assembly 20 extends from the upper part of the inner shell 2, and the electrically-controlled adjustment assembly 20 may be arranged in the accommodating chamber enclosed by the inner shell 2, the outer shell 3 and the bottom shell 4. A protective switch D of the cooking plate 12 may be arranged on the inner side of the base assembly. When the cooking plate 12 is placed on the heating plate 11, the protective switch is inductively turned on, and the product is in an operation state where it can be heated; and, when the cooking plate 12 leaves the heating plate 11, the protective switch is turned off, and the product is in a standby state where it is not heated. As shown in FIGS. 7-8, the protective switch D includes an induction boss 24, a moving pin 15, a switch bracket 16 and a microswitch 17. The protective switch is fixed in the inner shell 2 and passes through the inner shell 2 and the heat insulating plate 5 to come into contact with the cooking plate 12 inductively. The induction boss is engaged with the moving pin 15, and the induction boss 24, the moving pin 15 and the microswitch 17 are all arranged on the switch bracket 16. After the cooking plate 12 is placed, the induction boss 24 of the protective switch will be pressed down, the induction boss will push the moving pin 15 to move back, and the moving pin then pushes the convex point of the microswitch 17, so that the circuit is connected. Conversely, after the cooking plate 12 is moved away, the elastic force of the microswitch 17 will push up the induction boss 24 for resetting through the moving pin 15, so that the product is powered off and in a standby state. Thus, the heating plate can be prevented from continuously heating and thus resulting in an accidental burn risk after the cooking plate is taken out.

In the cooking device according to Embodiment 2 of the present application, the circulation of the hot air can realize the flowing of oil fume vapor generated in the process of cooking, so that the moisture on the surface of the food is taken away and the surface of the food is crisp. In addition, the flowing oil fume vapor is blown to the cooking chamber for circulation through the air duct chamber and two rows of convection holes at two ends of the heating plate, avoiding accumulation and aggregation on the heating element. Meanwhile, a circle of overflow groove is formed between the heating plate and the heat insulating plate to reduce the assembly gap of the product, so that the cooking area is complete and integral, so that the fluid overflowed during the cooking process can be effectively stored, and the fluid can be prevented from entering the interior of the device. The whole structure design is easy to disassemble, so that the cooking device of the present application can be easy to clean and kept clean for a long time.

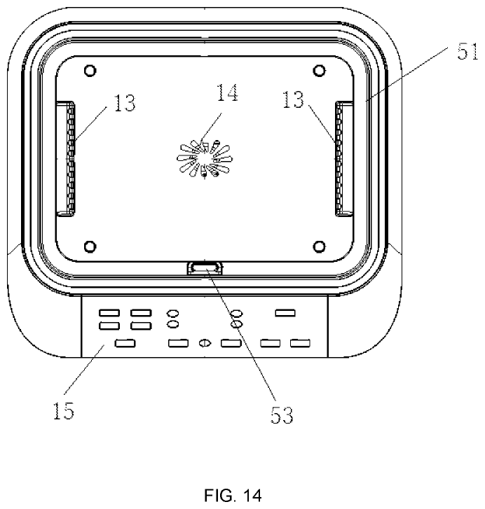

In accordance with Embodiment 3 of the cooking device of the present application, as shown in FIGS. 11-14, the cooking device includes a main body, a top cover 1 is arranged on the top of the main body, and the main body is covered with the top cover 1 to form a cooling chamber G. A control panel 9 is arranged in the front of the main body, and various control operations can be performed on the cooking device through the control panel 9. The main body includes an inner shell 2, an outer shell 3 and a bottom shell 4. A concave chamber for accommodating a heating assembly and an air duct is arranged in the inner shell 2, and the inner shell 2, the outer shell 3 and the bottom shell 4 enclose an accommodating chamber for accommodating electrical components or other components. A heat insulating plate 5 is arranged in the inner shell 2, and a heating assembly is arranged above the heat insulating plate 5. An oil collecting groove arranged circumferentially is formed on the upper edge of the heat insulating plate 5, and an oil leakage hole communicated with the oil collecting groove 51 is formed on the heat insulating plate 5.Grease produced during the cooking process can be collected in the oil collecting groove 51 through the inner wall of the cooking device and the sidewall of the heat insulating plate 5, and then discharged to an oil receiving box 15 through the oil leakage hole 53. The oil receiving box 15 is arranged below the bottom sheet 4 to store oil fume produced during the cooking process. The oil receiving box 15 can be drawn out independently, so that oil can be discharged conveniently, the accumulation of oil dirt in the device is avoided, and it is convenient to clean and maintain the whole cooking device.

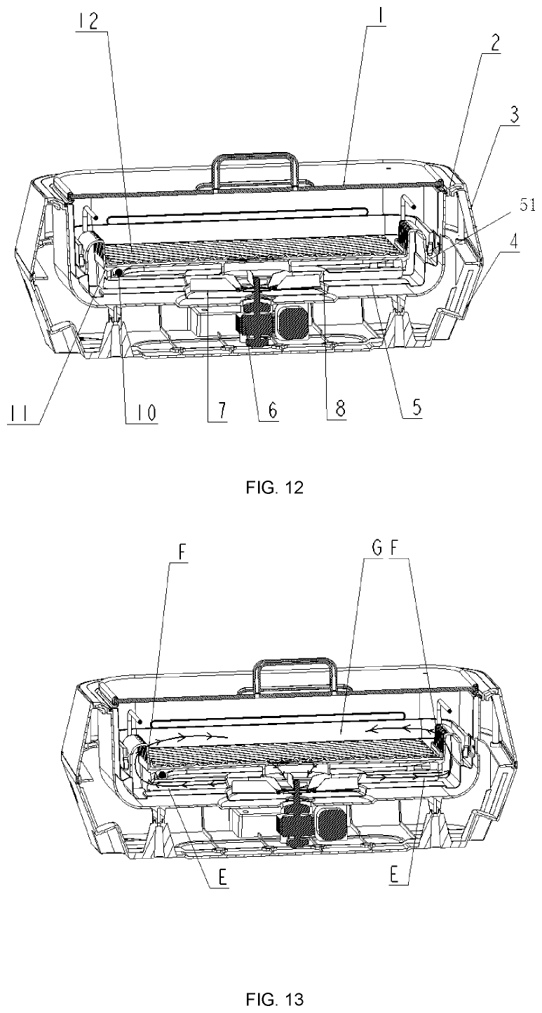

As shown in FIGS. 11-12, the heating assembly includes a heating element 10 and a heating plate 11 with a heat conduction function. The heating plate 11 is arranged above the heating element 10. An air duct 8 is arranged between the heat insulating plate 5 and the heating plate 11. The air duct 8 may be arranged on the heat insulating plate 5 of the main body and form an air duct chamber E with the heat insulating plate 5, or may be arranged on the bottom of the heating plate 11 and form an air duct chamber with the heating plate 11, or may be in other possible forms. Air outlets 13 are formed at two ends of the heating plate 11, and air inlets 14 are formed in the middle of the heating plate 11. The air duct chamber E is communicated with the air outlets 13 at two ends of the heating plate 11 and the air inlets 14 in the middle of the heating plate 11. A cooking plate 12 is placed on the heating plate 11, and air vents F are also formed at two ends of the cooking plate 12 and are communicated with the air outlets 13 at two ends of the heating plate 11 and the air duct chamber E. A gap is reserved between the cooking plate 12 and the heating plate 11 for allowing hot air in the cooking chamber G to circulate and flow back to the air inlets 14. The cooking plate 12 with a through hole on its bottom may also be adopted. It is to be noted that the positions and functions of the air outlets and the air inlets may be interchanged. In this case, it is only necessary to design the motor and the fan in opposite directions, that is, the air flow direction shown in FIG. 13 may also be designed as being opposite. The above alterations are simple alterations easily conceived and made by those skilled in the art based on the above disclosure, and shall also fall into the protection scope of the present application.

A motor 6 is arranged below the inner shell 2, and the motor 6 may be arranged in the accommodating chamber enclosed by the inner shell 2, the outer shell 3 and the bottom shell 4. A fan 7 is further arranged in the main body. The fan 7 is arranged in the air duct chamber E and fixedly connected to a motor shaft of the motor 6. The motor shaft of the motor 6 passes through the inner shell 2 and the heat insulating plate 5. A groove may be formed in the middle of the heat insulating plate 5 to be matched with the air duct 8 so as to increase the space for accommodating the fan. The motor 6 drives the fan 7 to rotate to blow heat to the cooking chamber G through the air duct chamber E and the air outlets 13 at two ends of the heating plate 11 for circulation. A negative pressure will be generated after air in the air duct chamber E is discharged from two ends, and the hot air in the cooking chamber G is sucked into the air duct chamber E through the air inlets 14, so that the hot air in the cooking chamber G circulates back and forth to evenly heat the food in the cooking plate. Meanwhile, the design of the flow channel can reduce the accumulation of oil fume at the heating element, thereby avoiding the trouble of cleaning the heating element.

In this embodiment, hot air is blown simultaneously from two ends of the cooking plate and then flows back from the middle of the cooking plate, so that the flow path of the hot air is shortened, oil fume can be gathered in the oil collecting groove more conveniently when passing through the oil collecting groove, and the accumulation of oil dirt on other parts of the device is reduced. Accordingly, the baking temperature in the cooking chamber can be increased quickly, the difference in temperature between different positions in the cooking chamber can be reduced, and cooking and heating are quick and even. In addition, the cooking device has the characteristics of low heat loss, easy cleaning and convenient disassembling.

Although the implementations of the present application are described above, the contents descried are only implementations used to understand the present application and not intended to limit the present application. Without departing from the spirit and scope disclosed by the present application, any person skilled in the art to which the application belongs can make any modifications and alterations to the forms and details of implementation. However, the protection scope of the present application shall still be subject to the scope defined by the appended claims.

1. A cooking device, comprising an inner shell, wherein a heat insulating plate is arranged in the inner shell; a heating assembly is arranged above the heat insulating plate; the heating assembly comprises a heating element and a heating plate; the heating plate is arranged above the heating element; an air duct is arranged between the heat insulating plate and the heating plate; air holes are formed at ends of the heating plate; a cooking plate is further arranged on the heating plate; air vents are formed on the cooking plate; the air vents are communicated with the air holes of the heating plate; and, the air duct is communicated with the air holes of the heating plate.

2. The cooking device according to claim 1, wherein an air hole is formed in the middle of the heating plate, the air duct is arranged on the heat insulating plate or on the bottom of the heating plate, and the air duct is communicated with the air hole.

3. The cooking device according to claim 2, wherein a gap is arranged between the cooking plate and the heating plate or a through hole is formed on the bottom of the cooking plate.

4. The cooking device according to claim 1, wherein a motor is arranged below the inner shell, a motor shaft of the motor is connected to a fan, and the fan is arranged in the air duct.

5. The cooking device according to claim 4, wherein the motor shaft penetrates through the heat insulating plate, a groove is formed on the heat insulating plate, the fan is arranged in the groove, and the groove is communicated with the air duct.

6. The cooking device according to claim 1, wherein the air vents are formed at two ends of the cooking plate, the air holes are formed at two ends of the heating plate, and the air vents of the cooking plate are communicated with the air holes of the heating plate.

7. The cooking device according to claim 6, wherein the air duct comprises an air duct plate, and the air duct plate is arranged on the heat insulating plate and forms an air duct chamber with the heat insulating plate.

8. The cooking device according to claim 7, wherein the air duct is communicated with the air vents of the cooking plate and the air holes of the heating plate.

9. The cooking device according to claim 1, wherein a heat reflector is arranged below the heating plate.

10. The cooking device according to claim 1, wherein the heat insulating plate is provided with an inclined concave surface, and the edge of the heating plate is fixedly attached to the inclined concave surface of the heat insulating plate to form an overflow groove.

11. The cooking device according to claim 10, wherein the heat insulating plate is matched with the inner shell in shape, and the edge of the heat insulating plate is connected to the edge of the inner shell through a clasp.

12. The cooking device according to claim 1, wherein a protective switch linked with the cooking plate is further provided, and the protective switch is fixed on the inner shell and passes through the inner shell and the heat insulating plate.

13. The cooking device according to claim 12, wherein the protective switch comprises an induction boss, a moving pin, a switch bracket and a microswitch; the induction boss is engaged with the moving pin; and, the induction boss, the moving pin and the microswitch are all arranged on the switch bracket.

14. The cooking device according to claim 1, wherein an oil collecting groove arranged circumferentially is formed on the upper edge of the heat insulating plate.

15. The cooking device according to claim 14, wherein an oil receiving box is further arranged on the bottom of the cooking device, and the oil receiving box is communicated with the oil collecting groove through an oil leakage hole.
